(19) United States
(12) Patent Application Publication
(10) Pub. No.: US 2003/0036937 A1
(43) Pub. Date: Feb. 20, 2003

(54) Method for control and coordination of independent tasks using benders decomposition

(76) Inventor: Mohammad Shahidehpour, Naperville, IL (US)

Correspondence Address: Mark E. Fejer, Pauley Petersen Kinne & Fejer, Suite 365, 2800 West Higgins Road, Hoffman Estates, IL, 60195, US

(21) Appl. No.: 09/827,595

(22) Filed: Mar. 6, 2001

(51) Int. Cl. G06F 17/60

(52) U.S. Cl. 705/8

(57) ABSTRACT

A method for supervisor control and coordination of independent tasks to be performed by a plurality of independent entities in which a plurality of schedules for performance of the independent tasks is generated and submitted to a master coordinator for approval and/or disapproval, resulting in generation of a plurality of approval and/or disapproval decisions by the master coordinator. The approval and disapproval decisions are returned to the independent entities which, in turn, adjust the schedules for which a disapproval decision has been returned, resulting in an adjusted schedule. The adjusted schedule is then returned to the master coordinator for reconsideration. These steps are repeated until all of the schedules have been approved.

### BACKGROUND OF THE INVENTION

1. Field of the Invention

This invention relates to the use of Benders decomposition, a technique for solving multi-stage stochastic linear programming problems by decomposing them into a set of smaller linear programming problems, for supervisory control and coordination of independent tasks to be performed by a plurality of independent entities. More particularly, this invention relates to the application of Benders decomposition to the problem of scheduling maintenance in deregulated power systems.

2. Description of Prior Art

The electric power industry is moving toward a deregulated market-based operation in which the unbundling of services will establish independent entities such as power generators (GENCOs), transmission providers (TRANSCOs), independent customers (DISCOs) and independent system operators (ISOs). In the past, the first three entities were monopolized, owned and operated by regulated electric power companies. However, in the market-based structure, the supervisory control and coordination of these independent entities will be a vital task for power systems operators.

In response to the electric industry restructuring, new phenomena, new circumstances, new risks, and new tools have emerged. Some of them arise due to the lack of experience with newborn issues, while others come as a necessity for the new structures. The electric power market differs from other commodity markets in that electric power cannot be stored and must be consumed as generated. This condition drastically changes the nature of supervisory control and coordination in this industry as compared with that in other industries. As a result, applying theorems and models of other commodities to electricity have frequently misled participants of restructured electricity markets. In this regard, a systematic approach which will provide the proper mechanism as individual companies schedule their own activities, satisfy their own constraints and optimize their own objectives is desirable. From the customers perspective, maximizing the system availability and reliability and minimizing the cost of power delivery are desirable objectives which require coordination and control among these companies.

Supervisory control may encompass different applications including the coordination of short-term and long-term maintenance scheduling of facilities in several independent power companies, fuel delivery and scheduling, and provision of ancillary services (dispersion of reserve capacity among power companies to sustain the continuity of service in the case of a contingency). It will be apparent that achievement of these objectives requires addressing various conflicting objectives, such as cost versus reliability, in power companies. It is imperative to maintain a certain level of reliability in a power system while individual companies within the system try to minimize their own cost of operation and maximize their revenues. Thus, it is clear that a systematic coordination and supervisory control is essential to assure the reliability of power delivery and to minimize power outages throughout the network.

Numerous methods relating to the planning and scheduling of maintenance for a variety of systems including power generation and distribution systems are disclosed by the prior art. For example, U.S. Pat. No. 5,798,939 to Ochoa et al. teaches a computer workstation-based interactive tool for assessing the reliability of power systems, which tool can be used to determine the effect on the reliability of both substations and bulk generation and transmission systems of system additions, design alternatives, maintenance practices, substation configurations, and spare part policies. U.S. Pat. No. 5,970,437 to Gorman et al. teaches a program for computerized management of plant maintenance which provides graphic representations of the mechanical and electrical systems of an operating plant where all of the components are treated as “objects” and associated through a relational database with text files providing component specifications, product identifications, component operating status, and all directly interconnected components including data as to flow direction and relative position in the system. For maintenance and service, each component is associated with existing and future specified work orders, and service requirements including consideration of probable life expectancy and the like. See also U.S. Pat. No. 5,311,562 to Palusamy et al. which teaches an integrated plant monitoring and diagnostic system for shared use by the operations, maintenance and engineering departments of a nuclear power plant; U.S. Pat. No. 4,843,575 to Crane which teaches an interactive, dynamic, real-time management system comprising a plurality of powered systems and a central management facility; and U.S. Pat. No. 6,006,171 to Vines et al. which teaches a computerized maintenance management system for the process control environment which integrates a computerized maintenance management system with a process control system.

### SUMMARY OF THE INVENTION

It is one object of this invention to provide a method for supervisory control and coordination of independent tasks in the deregulated electric power industry aimed at minimizing the possibility of blackouts, minimizing the cost of power delivery to customers, improving the system availability, and responding to environmental and regulatory concerns as individual power companies try to maximize their revenues.

It is another object of this invention to provide a method for supervisory control and coordination of independent tasks in the deregulated electric power industry which enables individual companies to schedule their own activities, satisfy their own constraints and optimize their own objectives while providing necessary coordination and control among these companies to maximize the system availability and reliability, and minimize the cost of power delivered to customers.

These and other objects of this invention are addressed by a method for supervisory control and coordination of independent tasks to be performed by a plurality of independent entities comprising the steps of a) generating a plurality of schedules for performance of the independent tasks; b) submitting the plurality of schedules to a master coordinator for approval or disapproval of the schedules, resulting in generation of approval and/or disapproval decisions by the master coordinator; c) returning the approval and/or disapproval decisions to the independent entities; d) adjusting the schedule for which a disapproval decision is returned, resulting in at least one adjusted schedule; and e) returning the adjusted schedule to the master coordinator for reconsideration. Steps b) through e) are repeated until all of the schedules have been approved.

Benders decomposition with its mathematical feature is a particularly suitable match for providing assistance to human operators for supervisory control and coordination in the electric power industry in which there are a number of independent companies, generation, transmission, distribution, and customers, with their own objectives and there is a coordinator, for example the ISO in the power grid, which will coordinate the proposed activities. The application of Benders decomposition enables coordination of various conflicting objectives in different power companies, thereby enabling maintenance of a certain level of reliability in the power system while individual companies within the system try to minimize their own cost of operation and maximize their revenues.

Although disclosed herein as being applicable to deregulated power systems, it will be apparent to those skilled in the art that the method of this invention employing Benders decomposition may be applied to any system requiring supervisory control and coordination of independent tasks to be performed by independent entities, and such applications are deemed to be within the scope of this invention.

### BRIEF DESCRIPTION OF THE DRAWINGS

These and other objects and features of this invention will be better understood from the following detailed description taken in conjunction with the drawings wherein:

FIG. 1 is diagram of an example of the Benders decomposition hierarchy in which the master problem represents the coordinator in the power grid and sub-problems identify individual power companies;

FIG. 2 is a diagram of a Benders decomposition as applied to maintenance scheduling;

FIG. 3 is a diagram showing application of the method of this invention as applied to multiple companies in a deregulated system; and

FIG. 4 is a diagram of load data for an exemplary three-bus system.

### DESCRIPTION OF PREFERRED EMBODIMENTS

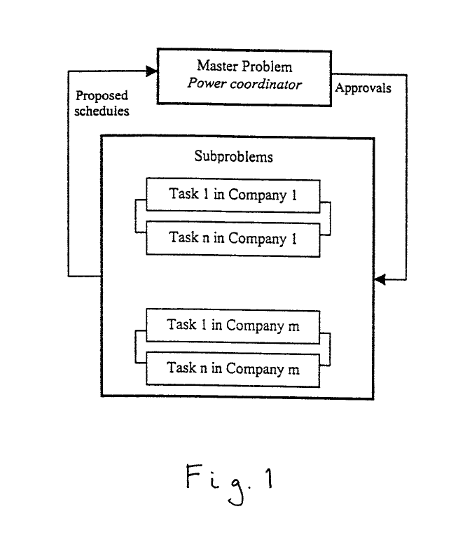

FIG. 1 shows an example of the Benders decomposition hierarchy in which the master problem represents the coordinator in the power grid and sub-problems identify individual power companies. The individual companies schedule their own activities and submit their proposed schedules to the master problem which will check various criteria and approve or disapprove the proposed schedules. The coordinator's decision is returned as Benders cuts to sub-problems which will correspondingly adjust their schedules if their proposals are not approved. Subsequent iterations follow before the implementation of proposed schedules until all criteria are met.

In the past, when a power system was operated as a regulated monopoly, most techniques for thermal generator maintenance scheduling were based on heuristic approaches. These approaches consider a generating unit separately in selecting its optimal outage interval subject to constraints and an objective criterion for equalizing or leveling reserves throughout the planning interval, minimizing expected total production costs or leveling the risk of failure to meet demand. An example of a heuristic approach would be to schedule one unit at a time beginning with the largest and ending with the smallest. Most methods, mainly those based on heuristics, represent only the generation system and do not take into account the network constraint effects on the unit maintenance. The method of this invention extends Benders decomposition to include coordination between a GENCO and a TRANSCO for the inclusion of network constraints in the maintenance scheduling problem.

The maintenance scheduling problem will determine the period for which generating units of a GENCO should be taken off line for plant preventive maintenance over the course of a one or two year planning horizon so that the total operating cost is minimized while system energy and reliability requirements as well as the number of other constraints in TRANSCO are satisfied. Since GENCO and TRANSCO are two separate entities, TRANSCO's network constraints in maintenance scheduling of generating units may be excluded. The exclusion may result in an optimistic solution which will not satisfy network flow constraints and cannot be implemented since generating units in a GENCO are distributed throughout the network and interconnected by transmission lines. This may lead to different risk levels to meet demand for a given amount of maintenance capacity outage depending on the unit location in the system. When network constraints are included, the problem becomes considerably more complex. The method of this invention is designed to address this problem.

In coordinating the activities of GENCO and TRANSCO through an ISO, the objective is to minimize total operating and maintenance costs over the operating planning period, subject to unit maintenance and network constraints. To calculate the maintenance schedule, it is essential that numerous and complex constraints which limit the choice of scheduling times are incorporated into the solution method. Constraints in the maintenance scheduling problem are categorized as coupling and decoupling constraints. A coupling constraint is the requirement that generating units be overhauled regularly. This is necessary to maintain their efficiency at a reasonable level, maintain the incidence of forced outages low, and prolong the life of units. This procedure is incorporated periodically by specifying minimum/maximum times that a generating unit may run without maintenance. The time required for overhauling a unit is generally known, and hence the number of weeks that a unit is “down” is predetermined. It is assumed for purposes of this discussion that there is very little flexibility in manpower usage for maintenance. Furthermore, only a limited number of units may be serviced at one time due to the limited manpower. The available crew could be split into geographical and organizational types. For purposes of this description, we assume that the number of crew in each type required at each stage of overhaul of each unit is specified.

Network constraints in a TRANSCO in each time period are considered as decoupling constraints. The network can be modeled as either the transportation model or a linearized power flow model. For purposes of this description, the transportation model is used to represent TRANSCO's operating limits and the peak load balance equation. Mathematically, a complete generator maintenance schedule can be formulated as follows:

$$Min {\sum }_{t} {\sum }_{i} \{ {C}_{it} ( 1 - {x}_{it} ) + {c}_{it} {g}_{it} \}$$

$$S . T .$$

maintenance constraints:

xᵢₜ=1 for t≦eᵢ or t≧lᵢ+dᵢ

xᵢₜ=0 for sᵢ≦t≦sᵢ+dᵢ

xᵢₜ=0 or 1 for eᵢ≦t≦lᵢ (i)

1. crew avalibility 2. resources availability 3. seasonal limitations 4. desirable schedule system constraits: (ii)

Sƒ+g+r=d∀t(iii)

g≦g·x∀t(iv)

r≦d∀t(v)

{ƒ{≦ƒ∀t(vii)

$$\begin{matrix}{\sum }_{i} {r}_{it} \leq ϵ & ∀ t & \end{matrix} \qquad ( vii )$$

where:

| | |
|---|---|
| Cᵢᵢ | generation maintenance cost for unit i at time t |
| cᵢₜ | generation cost of unit i at time t |
| xᵢₜ | unit maintenance status, 0 if unit is off-line for maintenance |
| sᵢ | period in which maintenance of generating unit i starts |
| eᵢ | earliest period for maintenance of generating unit i to begin |
| lᵢ | latest period for maintenance of generating unit i to begin |
| dᵢ | duration of maintenance for generating unit i |
| r | vector of dummy generators which corresponds to energy not served |
| | at time period t |
| \overline{f} | maximum line flow capacity in matrix term |
| f | active power flow in vector term |
| \overline{g} | maximum generation capacity in vector term |
| g | vector of (gᵢₜ) power generation for each unit at time t |
| d | vector of the demand in every bus at time t |
| S | node-branch incidence matrix |
| ε | acceptable level of expected energy not served |

The unknown variable xᵢₜ in (2-1) is restricted to integer values; on the other hand, gᵢₜ has continuous values. Therefore (2-1) corresponds to a mixed-integer programming problem.

The objective of (2-1) is to minimize the total maintenance and production cost in a GENCO over the operational planning period. The first term of objective function (2-1) is the maintenance cost of generators; the second is the energy production cost.

In (2-1), maintenance constraints (i) and (ii) represent GENCO's constraints. Also, constraints (i) represent the maintenance window stated in terms of the start of maintenance variables (sᵢ). The unit must not be in maintenance before its earliest period of maintenance (eᵢ) and latest period of maintenance (e.g., lᵢ+dᵢ). The set of constraints (ii) consists of crew and resources availability, seasonal limitations, desirable schedule, and other constraints such as fuel and environmental constraints. The seasonal limitations can be incorporated in eᵢ and lᵢ values of constraint (i). If units 1, 2 and 3 are to be maintained simultaneously, the set of constraints would be formed as follows:

x₁ₜ+x₂ₜ+x₃ₜ=3 or x₁ₜ+x₂ₜ+x₃ₜ=0

If in each maintenance area we have limited resources and crew available, the set of constraints would be formed as follows:

$${\sum }_{i ∈ A} {σ}_{m i} ( 1 - {x}_{it} ) \leq {Z}_{m t} \qquad \text{(2-2)}$$

In the case of resource constraints, Zₘₜ would be the amount of resource m available in area A for each time t and σₘᵢ would be a percentage of this resource required for unit i. In the case of crew constraints, the corresponding Zₜ would be the number of maintenance crew in area ω and σₘᵢ would be a percentage of this crew required for maintenance of unit i.

Constraints (iii)-(vi) represent the operation constraints checked by the ISO, in this case, peak load balance and other operation constraints such as generation and transmission capacity limits of the system. Constraint (vii) represents allowable energy unserved in the system. Benders decomposition is there applied to solve GENCO's and ISO set of equations in (2-1).

### Benders Decomposition

Before we discuss the solution methodology, let us present the Benders decomposition by considering the following general mixed integer program:

Min Px+p(g)

S.T. A₁x≦b₁

A₂x+u(g)≦b₂

g≧0

xᵢ=0 or 1 for all i (3-1)

where x is a vector of 0-1 variables with constant cost vector P and coefficient matrices A₁ and A₂; g is a vector of continuous variables with cost functions p and u; b₁ and b₂ are vectors of right hand side constants. Since the problem involves both discrete and continuous variables, it is unlikely that a direct approach to solve (3-1) would be computationally feasible. Instead the problem is partitioned as

Min Px+Min_{g≧0}{p(g)|u(g)≦b₂−A₂x}

S.T. A₁x≦b₁

xᵢ=0 or 1

x∈Ω (3-2)

where Ω is the set of x for which the constraints u(g)≦b₂-A₂x can be satisfied. For each fixed x, the resulting inner minimization problem is

Min p(g)

S.T. u(g)≦b₂−A₂x

g≧0 (3-3)

The Lagrangian relaxation of (3-3) is given by

L(α)=min_{g≧0}{p(g)+α(u(g)−(b₂−A₂x))} (3-4)

If g does satisfy u(g)≦b₂−A2x, the extra term in the objective will be non-positive and thus, for all α>0,

L(α)≦min_{g≧0}{p(g)|u(g)≦(b₂−A₂x)} (3-5)

The Lagrangian dual L is then defined by L=max_{α}L(α). Under certain conditions sufficient for strong duality,

L=min_{g≧0}{p(g)|u(g)≦(b₂−A₂x)} (3-6)

enabling us to replace the inner minimization of (3-2) by L. This replacement is justified later for our problem. With this replacement, (3-2) becomes

Min Px+Max_{α≧0}{L(α)}

S.T. A₁x≦b₁

xᵢ=0 or 1

x∈Ω (3-7)

If we let

$$\begin{matrix}z = Px + {max}_{α \geq 0} \{ L ( α ) \} \\ = Px + {max}_{α \geq 0} \{ {min}_{g \geq 0} \{ p ( g ) + α ( u ( g ) - ( {b}_{2} - {A}_{2} x ) ) \} \}\end{matrix}$$

then (3-7) is equivalent to

Min z

S.T. A₁x≦b₁

z≧Px+min_{g≧0}{p(g)+α(u(g)−(b₂−A₂x))} for all α

xᵢ=0 or 1

x∈Ω (3-8)

Constraints (3-8) are referred to as feasibility cuts.

To complete the derivation of the master problem, the set of constraints that ensure x∈Ω must be characterized. This condition is satisfied if and only if

max_{β≧0}{min_{g≧0}{p(g)+β(u(g)−(b₂−A₂x))}}≦∞

This condition is equivalent to

min_{g≧0}{β(u(g)−(b₂−A₂x))}≦0 for all β≧0 (3-9)

Constraints of this form are referred to as infeasibility cuts. Thus our master problem is

Min z

S.T. z≧Px+min_{g≧0}{p(g)+α(u(g)−(b₂−A₂x))} for all α>0min_{g≧0}{β(u(g)−(b₂−A₂x))}≦0 for all β≧0 (3-10)

xᵢ=0 or 1

The application of this method to our problem is discussed in the following section.

### Solution Methodology

Benders decomposition is applied to the generation maintenance problem as follows. If X denotes the vector of maintenance variables {xᵢₜ}, Ω represents the set of maintenance schedules for which constraints (iii)-(vii) are satisfied in all periods t, and operation cost wₜ is defined as

$${w}_{t} = {\sum }_{i} {c}_{it} {g}_{it}$$

then (2-1) can be written as

$$Min {\sum }_{t} {\sum }_{i} {C}_{it} ( 1 - {x}_{it} ) + {\sum }_{t} Min \{ {w}_{t} \vert ( iii ) - \{ vii ) \} \\ S . T . \qquad \text{(4-1)}$$

maintenance constraints:

xᵢₜ=1 for t≦eᵢ or t≧lᵢ+dᵢ

xᵢₜ=0 for sᵢ≦t≦sᵢ+dᵢ

xᵢₜ=0 or 1 for eᵢ≦t≦lᵢ (i)

1. crew availability 2. resources availablity 3. seasonal limitations 4. desirable schedule(ii)

X∈Ω

If the t^{th} sub-problem was a linear program, it could be replaced by its dual as is done in the standard Benders decomposition. The Lagrangian dual of the t^{th} sub-problem is given by

Lₜ=max_{κ,π,γ,ζ,μ≧0}{Lₜ(κ,π,γ,ζ,μ)} (4-2)

where Lₜ(κ,π,γ,ζ,μ) is the Lagrangian function and κ,π,γ,ζ,μ and μ are multipliers of constraints (iii)-(vii).

$${L}_{t} ( κ , π , γ , ζ , μ ) = {min}_{g \geq 0} \{ \begin{matrix}{w}_{t} + {\sum }_{i} {κ}_{it} ( {\sum }_{k} ( {S}_{ik} {f}_{kt} ) + {g}_{it} + {r}_{it} - {d}_{it} ) + \\ {\sum }_{i} {π}_{it} ( {g}_{it} - {\overline{g}}_{i} \cdot {x}_{it} ) + {\sum }_{i} {γ}_{it} ( {r}_{it} - {d}_{it} ) + \\ {\sum }_{k} {ζ}_{kt} ( \vert {f}_{kt} \vert - {\overline{f}}_{k} ) + {μ}_{t} ( ( {\sum }_{i} {r}_{it} ) - ϵ )\end{matrix} \} \qquad \text{(4-3)}$$

The t^{th} sub-problem is then placed by Lₜ, and (4-1) is rewritten as

$$Min {\sum }_{t} {\sum }_{i} {C}_{it} ( 1 - {x}_{it} ) + {L}_{t} \\ S . T . \qquad \text{(4-4)}$$

maintenance constraints:

xᵢₜ=1 for t≦eᵢ or t≧lᵢ+dᵢ

xᵢₜ=0 for sᵢ≦t≦sᵢ+dᵢ

xᵢₜ=0 or 1 for eᵢ≦t≦lᵢ (i)

| | | |
|---|---|---|
| 1. crew availability | 3. seasonal limitations | |
| 2. resources availability | 4. preschedule | (ii) |

X∈Ω

To ensure X∈Ω, the maintenance schedule must ensure that sufficient reserve exists to provide a secure supply while minimizing the cost of operation. The t^{th} sub-problem is feasible if and only if the optimal value of the following problem is less than ∈

$$Min {\sum }_{i} {r}_{it} \\ \begin{matrix}S . T . Sf + g + r = d \\ g \leq \overline{g} \cdot x \\ r \leq d \\ \vert f \vert \leq \overline{f}\end{matrix} \qquad \text{(4-5)}$$

Its Lagrangian dual is

max_{ν,λ,τ,η≧0}Uₜ(ν,λ,τ,η)

where Uₜ(ν,λ,τ,η) is the following Lagrangian function and ν,λ,τ and η are multipliers of constraints (iii)-(vii).

$${U}_{t} ( v , λ , τ , η ) = {min}_{g \geq 0} \{ \begin{matrix}{\sum }_{i} {r}_{it} + {\sum }_{i} {v}_{it} ( ( {\sum }_{k} {S}_{ik} {f}_{kt} ) + {g}_{it} + {r}_{it} - {d}_{it} ) + \\ {\sum }_{i} {λ}_{it} ( {g}_{it} - {\overline{g}}_{i} \cdot {x}_{it} ) + {\sum }_{i} {τ}_{it} ( {r}_{it} - {d}_{it} ) + \\ {\sum }_{k} {η}_{kt} ( \vert {f}_{kt} \vert - {\overline{f}}_{k} )\end{matrix} \}$$

We then arrive at the generalized Benders master problem:

$$Min z$$

$$S . T . \\ z \geq {\sum }_{t} {\sum }_{i} {C}_{it} ( 1 - {x}_{it} ) + \\ {\sum }_{t} {L}_{t} ( κ , π , γ , ζ , μ ) for all κ , π , γ , ζ , μ \geq 0$$

$${\sum }_{t} {U}_{t} ( v , λ , τ , η ) \leq ϵ for all v , λ , τ , η \geq 0$$

maintenance constraints:

xᵢₜ=1 for t≦eᵢ or t≧lᵢ+dᵢ

xᵢₜ=0 for sᵢ≦t≦sᵢ+dᵢ

xᵢₜ=0 or 1 for eᵢ≦t≦lᵢ (i)(4-6)

| | | |
|---|---|---|
| 1. crew availability | 3. seasonal limitations | |
| 2. resources availability | 4. desirable schedule | (ii) |

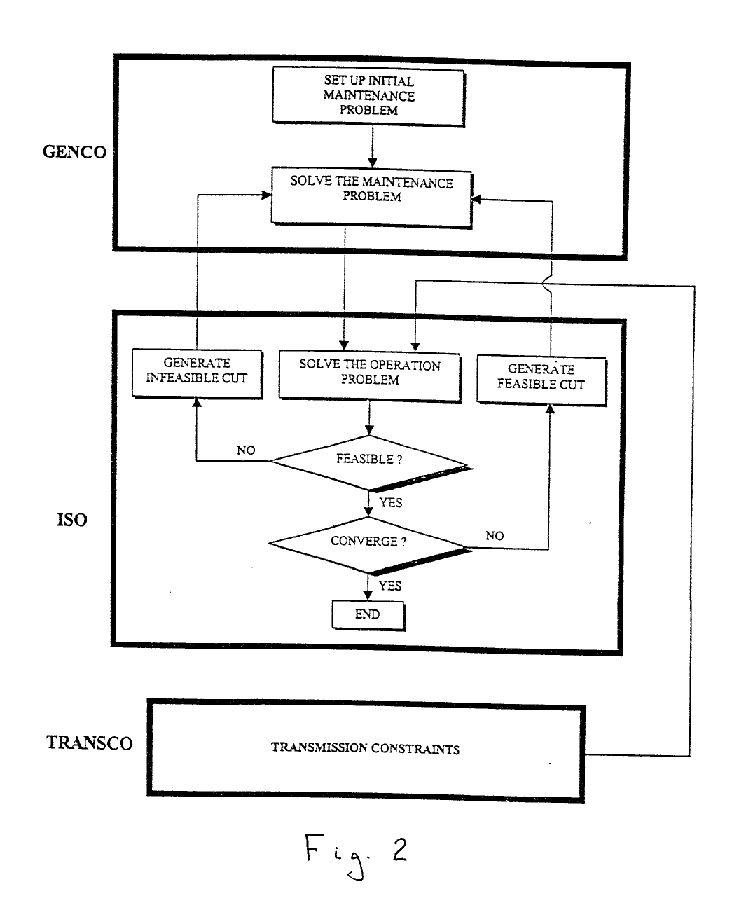

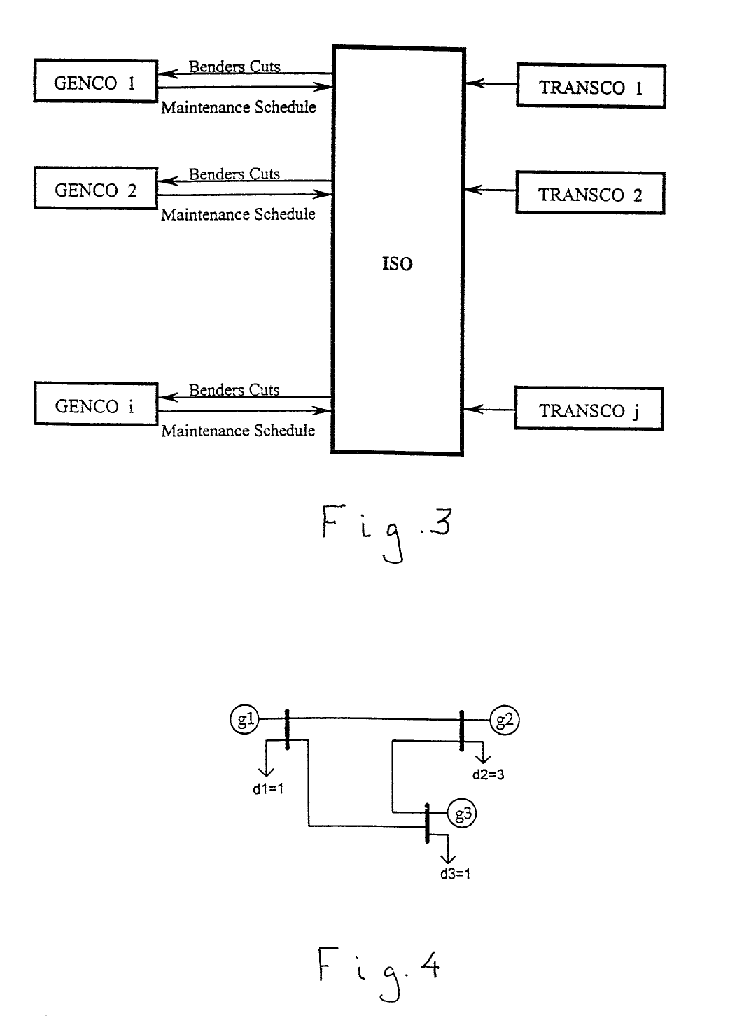

The problem is decomposed into a master problem and a set of independent operation sub-problems. The master problem, which in this model is an integer programming problem, is solved to generate a trial solution for maintenance schedule decision variables. This master problem is a relaxation of the original problem in that it contains only a subset of constraints. Its optimal objective value is a lower bound on the optimal value of the original problem. Once xᵢₜ variables are fixed, the resulting operation sub-problem can be treated as a set of independent sub-problems, one for each time period t, since there are no constraints across time periods. The set of operation sub-problems are then solved using the fixed maintenance schedule obtained from the solution of the master problem. At each iteration, the solution of sub-problems generates dual multipliers which measure the change in either production cost or reliability resulting from marginal changes in the trial maintenance scheduling. These dual multipliers are used to form one or more constraints (known as cuts) which are added to the master problem for the next iteration. The problem continues until a feasible solution is found whose cost is sufficiently close to lower bound, as shown in FIG. 2.

The initial maintenance master problem is formulated as follows:

$$Min z$$

$$S . T . z \geq {\sum }_{t} {\sum }_{i} \{ {C}_{it} ( 1 - {x}_{it} ) \}$$

maintenance constraints:

xᵢₜ=1 for t≦eᵢ or t≧lᵢ+dᵢ

xᵢₜ=0 for sᵢ≦t≦sᵢ+dᵢ

xᵢₜ=0 or 1 for eᵢ≦t≦lᵢ (4-7)

| | |
|---|---|
| 1. crew availability | 3. seasonal limitations |
| 2. resources availability | 4. desirable schedule |

### Operation Sub-Problem

The sub-problem may not have any solutions due to the fact that the unserved energy cannot be kept above a desired level. If a sub-problem is infeasible, then an infeasibility cut is generated. For each infeasible sub-problem resulting from the nth trial solution of the master problem, the infeasible cut is of the form

$${\sum }_{i} {r}_{it}^{n} + {\sum }_{i} {λ}_{it}^{n} {\overline{g}}_{i} ( {x}_{it}^{n} - {x}_{it} ) \leq ϵ \qquad \text{(4-8)}$$

The multiplier λᵢₜⁿ may be interpreted as a marginal decrease in energy not supplied with a 1 MW increase in generation, given the nth trial maintenance schedule. The infeasibility cuts (4-8) will eliminate maintenance values which are not possible to be scheduled.

If the sub-problem is feasible, then the fuel cost for period t, wₜ, depends on the utilization of the available units to satisfy load constraints in each time period subject to maintaining the unserved energy above a certain level. Thus the generation cost in period t can be expressed as

$${w}_{t} = Min {\sum }_{i} {c}_{it} {g}_{it} \\ S . T . Sf + g + r = d \\ g \leq \overline{g} {x}^{n} \\ r \leq d \\ \vert f \vert \leq \overline{f} \\ {\sum }_{i} {r}_{it} \leq ϵ \qquad \text{(4-9)}$$

The solution of the sub-problem is not complicated, since knowing which generators and transmissions are available during period t allows us to minimize the operation cost. The feasible cut is of the form

$$z \geq {\sum }_{t} ( {w}_{t}^{n} + {\sum }_{i} ( {C}_{it} ( 1 - {x}_{it}^{n} ) + {π}_{it}^{n} {\overline{g}}_{i} ( {x}_{it}^{n} - {x}_{it} ) ) ) \qquad \text{(4-10)}$$

where wₜⁿ is the expected fuel cost for period t associated with the n^{th} trial solution. The multiplier πᵢₜⁿ may be interpreted as the marginal cost associated with a 1 MW decrease in the power capacity, given the n^{th} trial maintenance schedule. The cost cuts (4-10) will tend to increase the lower bounds obtained from each successive maintenance sub-problem solution.

### Maintenance Master Problem

The maintenance master problem minimizes maintenance cost subject to maintenance constraints as well as feasibility and infeasibility cuts from the operation sub-problems. If all sub-problems are feasible, then their solutions yield a set of dual multipliers from which a feasibility cut is constructed. If one or more operation sub-problems are infeasible, then, for each infeasible sub-problem, an infeasibility cut is generated.

$$Min z$$

$$S . T . \\ z \geq {\sum }_{t} {\sum }_{i} \{ {C}_{it} ( 1 - {x}_{it} ) \}$$

maintenance constraints:

xᵢₜ=1 for t≦eᵢ or t≧lᵢ+dᵢ

xᵢₜ=0 for sᵢ≦t≦sᵢ+dᵢ

xᵢₜ=0 or 1 for eᵢ≦t≦lᵢ

1. crew availability 2. resources availability 3. seasonal limitations 4. desirable schedule

feasibility and infeasibility cuts from previous iterations

if all sub-problems are feasible then the feasible cut is:

$$z \geq {\sum }_{t} ( {w}_{r}^{n} + {\sum }_{i} {C}_{it} ( 1 - {x}_{it}^{n} ) + {π}_{it}^{n} {\overline{g}}_{i} ( {x}_{it}^{n} - {x}_{it} ) )$$

if one or more sub-problems are infeasible, then the infeasible cuts are:

$${\sum }_{i} {r}_{it}^{n} + {\sum }_{i} {λ}_{it}^{n} {\overline{g}}_{i} ( {x}_{it}^{n} - {x}_{it} ) \leq ϵ \\ ∀ t ∈ \text{infeasible} \text{sub-problem} \\ xε 0 , 1 \qquad \text{(4-11)}$$

where

n is the current number of iterations

λⁿ, πⁿ are the multiplier vectors at n^{th} iteration

The important feature of the Benders decomposition is the availability of upper and lower bounds to the optimal solution at each iteration. These bounds can be used as an effective convergence criterion. The critical point in the decomposition is the modification of objective function based on the solution of the operation sub-problem. Associated with the solution of the operation sub-problem is a set of dual multipliers which measure changes in system operating costs caused by marginal changes in the trial maintenance. These multipliers are used to form a linear constraint, written in terms of maintenance variable x. This constraint, known as Benders cut, is returned to the maintenance problem which is modified and solved again to determine a new trial maintenance plan.

### EXAMPLE

We use a three-bus system as an example. The maximum energy not served requirement (∈) is 0 p.u., and generator and line input data in per unit for GENCO and TRANSCO are given in Tables 1 and 2. Load data are depicted in FIG. 2. , GENCO will perform maintenance on at least one generator. We assume the study period represents one time interval. Loads are assumed constant during the study period.

TABLE 1
Generator Data (GENCO)

| | Min Capacity | Max Capacity | | Maint. Cost/Unit |
|---|---|---|---|---|
| Unit | (p.u.) | (p.u.) | Cost ($) | ($) |
| 1 | 0.5 | 2.5 | 10 g₁ | 300 |
| 2 | 0.6 | 2.5 | 10 g₂ | 200 |
| 3 | 0.6 | 3.0 | 10 g₃ | 100 |

TABLE 2
Line Data (TRANSCO)

| Line | Ω/line | # of lines | Capacity/line (p.u.) |
|---|---|---|---|
| 1-2 | 0.2 | 2 | 0.25 |
| 2-3 | 0.25 | 2 | 0.5 |
| 1-3 | 0.4 | 2 | 0.25 |

First, we solve the initial maintenance master problem.

GENCO's Maintenance Problem (iteration 1):

Min z

S.T. 300*(1−x₁)+200*(1−x₂)+100*(1−x₃)≦z

x₁+x₂+x₃≦2

X₁≦1 x₂≦1 x₃≦1

The solution is:

x₁=1

x₂=1

x₃=0

z=100

ISO's operation problem (iteration 1):

We check the feasibility of the operation sub-problem given the first trial of maintenance schedule. The feasibility check is given as follows:

| | |
|---|---|
| Min | r₁ + r₂ + r₃ |

| S.T. | −f₁₂ − f₁₃ + g₁ + r₁ = 1 | Load balance at bus | 1 |
|---|---|---|---|
| | −f₂₃ + f₁₂ + g₂ + r₂ = 3 | Load balance at bus | 2 |
| | f₁₃ + f₂₃ + g₃ + r₃ = 1 | Load balance at bus | 3 |

| | |
|---|---|
| 0.5 ≦ g₁ ≦ 2.5 | Generator 1 limit |
| 0.6 ≦ g₂ ≦ 2.5 | Generator 2 limit |
| 0.0 ≦ g₃ ≦ 0.0 | Generator 3 limit |

| | |
|---|---|
| −2*0.25 ≦ f₁₂ ≦ 2*0.25 | Line 1-2 flow limit |
| −2*0.25 ≦ f₁₃ ≦ 2*0.25 | Line 1-3 flow limit |
| −2*0.5 ≦ f₂₃ ≦ 2*0.5 | Line 2-3 flow limit |

The primal solution of the feasibility check is:

r=0.5

g₁=2

g₂=2.5

g₃=0

f₁₂=0.5

f₁₃=0.5

f₂₃=0

The dual price of the operation sub-problem is:

λ_{g1}=0

λ_{g2}=1

λ_{g3}=1

The above LP solution is infeasible, since r₁+r₂+r₃≧0. The generation cost is set arbitrarily to 1000 because the solution is infeasible. The infeasible cut is:

0.5+1*2.5(1−x₂)+1*3*(0−x₃)≦0

GENCO's Maintenance Problem (Iteration 2):

Min z

S.T. 300*(1−x₁)+200*(1−x₂)+100*(1−x₃)≦z 0.5+1*2.5*(1−x₂)+1*3*(0−x₃)≦0.5 x₁+x₂+x₃≦2 x₁≦1 x₂≦1 x₃≦1

The solution is:

x₁=1

x₂=0

x₃=1

z=200

ISO's Operation Problem (Iteration 2):

The feasibility check is as follows:

| | |
|---|---|
| Min | r₁ + r₂ + r₃ |

| S.T. | −f₁₂ − f₁₃ + g₁ + r₁ = 1 | Load balance at bus | 1 |
|---|---|---|---|
| | −f₂₃ + f₁₂ + g₂ + r₂ = 3 | Load balance at bus | 2 |
| | f₁₃ + f₂₃ + g₃ + r₃ = 1 | Load balance at bus | 3 |

| | |
|---|---|
| 0.5 ≦ g₁ ≦ 2.5 | Generator 1 limit |
| 0.0 ≦ g₂ ≦ 0.0 | Generator 2 limit |
| 0.6 ≦ g₃ ≦ 3.0 | Generator 3 limit |

| | |
|---|---|
| −2*0.25 ≦ f₁₂ ≦ 2*0.25 | Line 1-2 flow limit |
| −2*0.25 ≦ f₁₃ ≦ 2*0.25 | Line 1-3 flow limit |
| −2*0.5 ≦ f₂₃ ≦ 2*0.5 | Line 2-3 flow limit |

The primal solution of feasibility check is:

r=1.5

g₁=1.5

g₂=0

g₃=2

f₁₂=0.5

f₁₃=0

f₂₃=−1

The dual price of the operation sub-problem is:

λ_{g1}=0

λ_{g2}=1

λ_{g3}=0

The above LP solution is infeasible, since r₁+r₂+r₃≧0. The generation cost is set arbitrarily to 1000 because the solution is infeasible. The infeasible cut is as follows:

1.5+1*2.5*(1−x₂)≦0

GENCO's Maintenance Problem (Iteration 3):

Min z

S.T. 300*(1−x₁)+200*(1−xg₂)+100*(1−xg₃)≦z

0.5+1*2.5*(1−x₂)+1*3*(0−x₃)≦0.5

1.5+1*2.5*(1−x₂)≦0

x₁+x₂+x₃≦2

x₁≦1 x₂≦1 x₃≦1

The solution is:

x₁=0

x₂=1

x₃=1

z=300

Given the trial maintenance schedule in iteration 3, we apply the feasibility check as before which gives t-0. This means the trial schedule is feasible now.

ISO's Operation Problem (Iteration 3):

The feasible problem is as follows

| | |
|---|---|
| Min | w = 10*g₂ + 10*g₃ + 300 |

| S.T. | −f₁₂ − f₁₃ + g₁ + r₁ = 1 | Load balance at bus | 1 |
|---|---|---|---|
| | −f₂₃ + f₁₂ + g₂ + r₂ = 3 | Load balance at bus | 2 |
| | f₁₃ + f₂₃ + g₃ + r₃ = 1 | Load balance at bus | 3 |

| | |
|---|---|
| 0.0 ≦ g₁ ≦ 0.0 | Generator 1 limit |
| 0.6 ≦ g₂ ≦ 2.5 | Generator 2 limit |
| 0.6 ≦ g₃ ≦ 3.0 | Generator 3 limit |

| | |
|---|---|
| −2*0.25 ≦ f₁₂ ≦ 2*0.25 | Line 1-2 flow limit |
| −2*0.25 ≦ f₁₃ ≦ 2*0.25 | Line 1-3 flow limit |
| −2*0.5 ≦ f₂₃ ≦ 2*0.5 | Line 2-3 flow limit |
| r₁ + r₂ + r₃ ≦ 0 | |

The primal solution is:

w=350

g₂=2.5

g₃=2.5

f₁₂=−0.5

f₁₃=−0.5

f₂₃=−1

The dual price of the operation sub-problem is:

π_{g1}=0

π_{g2}=−10

π_{g3}=−10

The feasible cut for the third iteration is:

z≧350−10*2.5*(1−x₂)−10*2.5*(1−x₃)

GENCO's Maintenance Problem (Iteration 4):

Min z

S.T. 300*(1−x₁)+200*(1−x₂)+100*(1−x₃)≦z

0.5+1*2.5*(1−x₂)+1*3*(0−x₃)≦0.5

1.5+1*2.5*(1−x₂)≦0

z≧350−10*2.5*(1−x₂)−10*2.5*(1−x₃)

x₁+x₂+x₃≦2

x₁≦1 x₂≦1 x₃≦1

The solution is:

x₁=0

x₂=1

x₃=1

z=350

We stop here since z=w which means the cost is equal to the lower bound.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

I claim:

1. A method for supervisory control and coordination of independent tasks to be performed by a plurality of independent entities comprising the steps of:
a) generating a plurality of schedules for performance of said independent tasks;
b) submitting said plurality of schedules to a master coordinator for one of approval and disapproval of said schedules, resulting in generation of a plurality of at least one of an approval decision and a disapproval decision by said master coordinator;
c) returning said plurality of said at least one of an approval decision and a disapproval decision to said independent entities;
d) adjusting said schedule for which a disapproval decision is returned, resulting in at least one adjusted schedule; and
e) returning said at least one adjusted schedule to said master coordinator for reconsideration.

2. A method in accordance with claim 1, wherein steps b) through e) are repeated until all said schedules have been approved.

3. A method in accordance with claim 2, wherein said schedules are implemented after all said schedules have been approved.

4. A method in accordance with claim 1, wherein said master coordinator is a power coordinator in a power grid.

5. A method in accordance with claim 4, wherein said independent entities are individual power companies.
